(19) United States
(12) Patent Application Publication
(10) Pub. No.: US 2011/0174158 A1
(43) Pub. Date: Jul. 21, 2011

(54) PARTICLE FILTER SYSTEM INCORPORATING ELECTRET NANOFIBERS

(75) Inventors: Howard J. Walls, Apex, NC (US); David S. Ensor, Chapel Hill, NC (US); Anthony L. Andrady, Apex, NC (US); Teri A. Walker, Durham, NC (US)

(73) Assignee: Research Triangle Institute, Research Triangle Park, NC (US)

(21) Appl. No.: 12/992,108

(22) PCT Filed: May 13, 2009
(86) PCT No.: PCT/US09/43789

§ 371 Date: Mar. 24, 2011

Related U.S. Application Data
(60) Provisional application No. 61/071,698, filed on May 13, 2008.

(51) Int. Cl. B03C 3/34; B29C 47/00; B82Y 99/00

(52) U.S. Cl. 96/60; 264/465; 977/902; 977/832

(57) ABSTRACT

A filtration device including a filtration medium having a plurality of nanofibers of diameters less than 1 micron formed into a fiber mat in the presence of an abruptly varying electric field during electrospinning of the plurality of nanofibers. The nanofibers retain charge in the filtration medium from the electrospinning. The filtration device includes a support attached to the filtration medium and having openings for fluid flow therethrough. A method for making a filter material. The method provides a support having openings for fluid flow therethrough, electrospins nanofibers across an entirety of the openings, abruptly varies an electric field at the collector at least once during electrospinning of the fibers, and retains charge on the nanofibers after formation of the filtration medium.

### CROSS REFERENCE TO RELATED APPLICATIONS

This application is related to U.S. application Ser. No. 10/819,916, filed on Apr. 8, 2004, entitled “Electrospinning of Polymer Nanofibers Using a Rotating Spray Head,” Attorney Docket No. 241015US-2025-2025-20, the entire contents of which are incorporated herein by reference. This application is also related to U.S. application Ser. No. 10/819,942, filed on Apr. 8, 2004, entitled “Electrospray/electrospinning Apparatus and Method,” Attorney Docket No. 241013US-2025-2025-20, the entire contents of which are incorporated herein by reference. This application is related to U.S. application Ser. No. 10/819,945, filed Apr. 8, 2004, entitled “Electrospinning in a Controlled Gaseous Environment,” Attorney Docket No. 245016US-2025-2025-20, the entire contents of which are incorporated herein by reference. This application is related to U.S. Ser. No. 11/130,269, filed May 17, 2005 entitled “Nanofiber Mats and Production Methods Thereof,” Attorney Docket No. 256964US-2025-2025-20, the entire contents of which are incorporated herein by reference. This application is related to U.S. application Ser. No. 11/559,282, filed on Nov. 13, 2006, entitled “Particle Filter System Incorporating Nanofibers,” Attorney Docket No. 283730US-2025-2025-20, the entire contents of which are incorporated herein by reference.

### BACKGROUND OF THE INVENTION

1. Field of the Invention

The present invention is related to nanofibers, methods and devices for electrospinning, methods and devices for depositing the nanofibers, and filters and other articles formed from the deposited nanofibers.

2. Description of the Related Art

The filtration industry has traditionally manufactured particulate air filters using conventional medium such as glass, cotton or polymer fibers made provided as rolled goods. The fibrous media may be made by non-woven processes such as wet laid paper, melt blown-spinning or woven yarn. The material is then transported to equipment where the media is cut, pleated, supported, glued into filter frames, and tested for leaks. Various measures of the properties of the rolled goods include appropriate weight per unit area, porosity, etc.

The porous filter media may be pleated or bonded into bags to increase the area of the media within individual filter units to reduce pressure drop. Often screens and other supports are added to prevent collapse of the media from the force of air flowing through the filter unit as dust is collected. Depending on the intended use of the filter, the filter may be tested with an appropriate challenge aerosol at a rated or standard airflow rate for pressure drop and particle collection efficiency. (e.g., ASHRAE 52.2, MIL-STD-282, IEST RP-CC 007.1, NIOSH APRS-STP-0051-00, and NIOSH APRS-0057-00 may be used to test the filters)

Theoretically, a reduction of the diameter of the fibers in a filter has the potential of causing an improvement of the filter system performance. For high efficiency filtration, fiberglass wet-laid papers are widely used having fiber diameters in the 200 nm to 5000 nm size range with the fiber sizes intentionally blended for both durability and filtration performance.

One technique for producing a smaller fiber diameter, and hence a potential for generating improved filtration media, is electrospinning of polymers to make submicron and nanofibers. Electrospinning as currently practiced uses a constant voltage to drive the spinning process defined herein as static field electrospinning.

However, electrospun nanofibers smaller than 500 nm are typically fragile, difficult to produce, and difficult to handle. One conventional approach has been to deposit nanofibers onto a conventional porous filter media to make a layered nanofiber filter media. The following patents describe conventional ways to fabricate nanofiber containing filters for various applications: U.S. Pat. Nos. 7,008,465; 6,994,742; 6,974,490; 6,955,775; 6,924,028; 6,875,256; 6,875,249; 6,800,117; 6,746,517; 6,743,273; 6,740,142; 6,716,274; and 6,673,136, and U.S. patent application Ser. Nos. 10/757,924 and 10/676,185; the entire contents of each of these patents are incorporated in entirety herein by reference.

Conventional layered nanofiber filters made from nanofibers deposited on conventional porous filter media have inherent limitations. The support media of these filters is usually pliable enough to allow pleating or manipulation during the assembly step. Such a pliable substrate media may flex or stretch from the air pressure drop force and may break or debond the nanofibers. The support layer of conventional media may contribute substantially to the pressure drop of the whole structure.

An ideal particulate filter is the one that would give the highest particle collection efficiency (lowest particle penetration) with the least pressure drop. One criterion for comparing filters of different thickness is the filter quality factor or figure of merit (FoM). The greater the value of FoM, the better the filter will perform (Hinds, 1982). One expression for this parameter is given by:

FoM=−Log(Pt)/ΔP (1)

where: Pt is the fractional penetration of a specific aerosol particle diameter (efficiency=(1−Pt)), and ΔP is the pressure drop corresponding to a specific face velocity of the filter (volumetric air flow divided by filter cross sectional area). As used herein, figure of merit given by −Log(Pt)/ΔP, where Pt is the fractional penetration of a specific aerosol particle diameter and ΔP is a pressure drop across the filtration medium corresponding to a face velocity of 5.3 cm/s and particle size of 0.3 microns.

Typically, the FoM of a high efficiency particulate air (HEPA) glass fiber media is 12 kPa⁻¹ measured at a face velocity of 5.33 cm/s and 0.3 μm particle diameter. These are the standard conditions for HEPA media tests (i.e., IEST RP-CC021.1).

The FoM of the layered nanofiber conventional porous filter media described above is limited by the relatively large fiber diameters of the coarse substrate which produce a relatively low FoM. The FoM of the layered nanofiber conventional porous filter media composite depends on the relative quantities of layers of nanofibers and conventional media and their respective FoM. In other words, while the individual layers of nanofibers may have a higher FoM than the conventional porous filter media substrate, the composite FoM is closer to the value of the convention porous filter media substrate because of the relative quantities of materials used in the conventional approach. Therefore at the current state-of-the-art, conventional layered nanofiber filter media do not provide filters with significantly greater FoM than conventional fiberglass media.

References describing various background materials and filter testing procedures include:
1. ASHRAE (1999) Method of Testing General Ventilation Air-Cleaning Devices for Removal Efficiency by Particle Size, Standard 52.2-1999. American Society of Heating, Refrigerating and Air-Conditioning Engineers, Inc. 1791 Tullie Circle, N. E. Atlanta, USA.
2. Ahn, Y. C., S. K. Park, et al. (2005). “Development of high efficiency nanofilters made of nanofibers.” Current Applied Physics: In press (accessed online).
3. Dhaniyala, S, and B. Y. H. Liu (1999a). “Investigations of particle penetration in fibrous filters part I. Experimental.” Journal of the TEST 42(1): 32-40.
4. Dhaniyala, S, and B. Y. H. Liu (1999b). “Investigations of particle penetration in fibrous filters Part II. Theoretical.” Journal of the IEST 42(2): 40-46.
5. Hinds, W. C. (1982). Aerosol Technology. New York, John Wiley & Sons, Inc.
6. IEST (1992) Institute of Environmental Sciences, Testing ULPA Filters. IEST RP-CC 007.1 Institute of Environmental Science and Technology, Rolling Meadows, USA.
7. IEST (1995) Institute of Environmental Sciences and Technology (1995) Testing HEPA and ULPA Filter Media, IEST-RP-CC021.1, Rolling Meadows, Ill.
8. MIL-STD-282, Filter units, Protective Clothing, Gas-mask Components and Related Products Performance Test Methods, US Government Printing Office, May 28, 1956.
9. National Institute for Occupational Safety and Health (NIOSH) Particulate Filter Penetration Procedure to Test Negative Pressure Respirators against Liquid Particulates (Procedure APRS-STP-0051-00) Morgantown, W. Va.: NIOSH Division of Safety Research, 1955.
10. National Institute for Occupational Safety and Health (NIOSH) Particulate Filter Penetration Procedure to Test Negative Pressure Respirators against Solid Particulates (Procedure APRS-STP-0057-00) Morgantown, W. Va.: NIOSH Division of Safety Research, 1955.
11. Park, H. S, and Y. O. Park (2005). “Filtration properties of electrospun utrafine fiber webs.” Korean Journal of Chemical Engineering 22(1): 165-172.
12. Schreuder-Gibson, H. L., P. Gibson, et al. (2004). “Cooperative charging effects of fibers from electrospinning of electrically dissimilar polymers.” International Nonwovens Journal 13(4): 39-45.
13. Thomas, D., P. Contal, V. Renaudin, P. Penicot, D. Leclerc and J. Vendel (1999) Modelling pressure drop in HEPA filters during dynamic filtration. J. Aerosol Science, 30(2)235-246.
14. S. Payet, D. Boulaud, G. Madelaine and A. Renoux (1992) Penetration and pressure drop of a HEPA filter during loading with submicron liquid particles. J. Aerosol Science 23(7). 723-735.
15. Bhattarai, S. R., N. Bhattarai, et al. (2004). “Novel biodegradable electrospun membrane: scaffold for tissue engineering.” Biomaterials 25(13): 2595-2602.
16. Boudriot, U., B. Goetz, et al. (2005). “Role of electrospun nanofibers in stem cell technologies and tissue engineering.” Macromolecular Symposia 225: 9-16.
17. Choi, S. S., Y. S. Lee, et al. (2004). “Electrospun PVDF nanofiber web as polymer electrolyte or separator.” Electrochimica Acta 50(2-3): 339-343.
18. Choi, S. W., S. M. Jo, et al. (2003). “An electrospun poly(vinylidene fluoride) nanofibrous membrane and its battery applications.” Advanced Materials 15(23): 2027-2032.
19. Jia, H. F., G. Y. Zhu, et al. (2002). “Enzyme-carrying polymeric nanofibers prepared via electrospinning for use as unique biocatalysts.” Biotechnology Progress 18(5): 1027-1032.
20. Liu, H. Q., J. B. Edel, et al. (2006). “Electrospun polymer nanofibers as subwavelength optical waveguides incorporating quantum dots.” Small 2(4): 495-499.
21. Zhang, Y. Z., C. T. Lim, et al. (2005). “Recent development of polymer nanofibers for biomedical and biotechnological applications.” Journal of Materials Science-Materials in Medicine 16(10): 933-946.
22. Aussawasathien, D., J. H. Dong, et al. (2005). “Electrospun polymer nanofiber sensors.” Synthetic Metals 154(1-3): 37-40.
23. Chronakis, I. S. (2005). “Novel nanocomposites and nanoceramics based on polymer nanofibers using electrospinning process—A review.” Journal of Materials Processing Technology 167(2-3): 283-293.
24. Demir, M. M., M. A. Gulgun, et al. (2004). “Palladium nanoparticles by electrospinning from poly(acrylonitrile-co-acrylic acid)-PdCl2 solutions. Relations between preparation conditions, particle size, and catalytic activity.” Macromolecules 37(5): 1787-1792.
25. Ding, B., M. Yamazaki, et al. (2005). “Electrospun fibrous polyacrylic acid membrane-based gas sensors.” Sensors and Actuators B-Chemical 106(1): 477-483.
26. Huang, Z. M., Y. Z. Zhang, et al. (2003). “A review on polymer nanofibers by electrospinning and their applications in nanocomposites.” Composites Science and Technology 63(15): 2223-2253.
27. Spasova, M., N. Manolova, et al. (2004). “Preparation of chitosan-containing nanofibres by electrospinning of chitosan/poly(ethylene oxide) blend solutions.” E-Polymers.
28. Davies, C. N. (1952). “The separation of airborne dust and mist particles.” Proceedings of the Institution of Mechanical Engineers. 1B(5): 185-198.
29. Jia, H. F., G. Y. Zhu, et al. (2002). “Enzyme-carrying polymeric nanofibers prepared via electrospinning for use as unique biocatalysts.” Biotechnology Progress 18(5): 1027-1032.
30. Katti, D. S., K. W. Robinson, et al. (2004). “Bioresorbable nanofiber-based systems for wound healing and drug delivery: Optimization of fabrication parameters.” Journal of Biomedical Materials Research Part B-Applied Biomaterials 70B(2): 286-296.
31. Kenawy, E. R. and Y. R. Abdel-Fattah (2002). “Antimicrobial properties of modified and electrospun poly(vinyl phenol).” Macromolecular Bioscience 2(6): 261-266.
32. Khil, M. S., D. I. Cha, et al. (2003). “Electrospun nanofibrous polyurethane membrane as wound dressing.” Journal of Biomedical Materials Research Part B-Applied Biomaterials 67B(2): 675-679.
33. Liu, H. Q., J. Kameoka, et al. (2004). “Polymeric nanowire chemical sensor.” Nano Letters 4(4): 671-675.
34. Luong-Van, E., L. Grondahl, et al. (2006). “Controlled release of heparin from poly(epsilon-caprolactone) electrospun fibers.” Biomaterials 27(9): 2042-2050.
35. Ma, Z. W., M. Kotaki, et al. (2005). “Potential of nanofiber matrix as tissue-engineering scaffolds.” @Tissue Engineering 11(1-2): 101-109.
36. Murugan, R. and S. Ramakrishna (2006). “Nano-featured scaffolds for tissue engineering: A review of spinning methodologies.” Tissue Engineering 12(3): 435-447.

The entire contents of these references are incorporate herein by reference.

### SUMMARY OF THE INVENTION

In one embodiment of the present invention, there is provided a filtration device including a filtration medium having a plurality of nanofibers of diameters less than 1 micron formed into a fiber mat in the presence of an abruptly varying electric field during electrospinning of the plurality of nanofibers. The nanofibers retain charge in the filtration medium from the electrospinning. The filtration device includes a support attached to the filtration medium and having openings for fluid flow therethrough.

In one embodiment of the present invention, there is provided a filtration device including a support having openings for fluid flow therethrough. The filtration device includes a filtration medium having a plurality of fibers attached to the support. The fibers retain charge in the filtration medium. The filtration medium has a figure of merit greater than 20 kPa⁻¹, where the figure of merit is given by −Log(Pt)/ΔP, where Pt is the fractional penetration of a specific aerosol particle diameter and ΔP is a pressure drop across the filtration medium corresponding to a face velocity of 5.3 cm/s and particle size of 0.3 microns.

In one embodiment of the present invention, there is provided a method for forming a filter material. The method includes providing a support having openings for fluid flow therethrough, electrospinning nanofibers across an entirety of the openings, abruptly varying an electric field at the collector at least once during electrospinning of the fibers, and retaining charge on the nanofibers after formation of the filtration medium.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic diagram showing according to one embodiment of the present invention an apparatus for electrospinning in a controlled environment;

FIG. 2 is a schematic diagram showing according to one embodiment of the present invention details of a device called dynamic field electrospinning for controlling deposition of the nanofibers;

FIG. 3 is data of the support mesh (secondary electrode) time varying potential and corresponding current flowing through a voltage limiting device (VLD) associated with the support mesh illustrating one element of dynamic field electrospinning; and

FIG. 4 is a flowchart depicting a method of the invention.

### DETAILED DESCRIPTION OF THE INVENTION

The invention described here provides for the fabrication of nanofiber mats that could be used, for example, but are not limited to filtration applications. The invention can also be applied to a wide range of other areas such as single filaments, yarns, nonwoven materials and membranes. Marked improvements in filter performance, as indicated by FoM, are provided for in various embodiments of the invention.

In one embodiment of the invention, a dynamic field electrospinning technique is used to produce the various articles defined herein and/or used in applications including filaments, yarns, nonwovens, and membranes. The invention utilizing the dynamic field electrospinning is particularly applicable to the field of filtration utilizing nanofiber based materials, especially nanofiber based electret filters. The morphology of the resultant nanofiber mat coupled with the lack of use of nonwoven filter media to support the nanofibers affect the resultant filter FoM. Other aspects provided by the invention include: (1) filters, filter devices, or filter materials with lower pressure drop and/or better filtration efficiency reflected in an improved filter FoM, (2) reduction in the most penetrating particle size, and (3) methods for fabricating filters, filter devices, or filter materials.

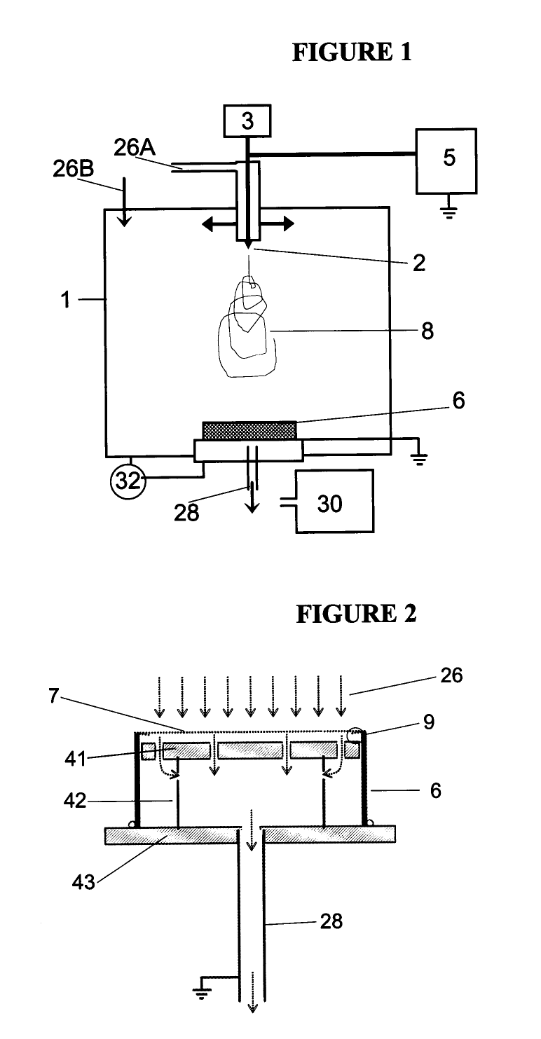

Referring now to the drawings, wherein like reference numerals designate identical or corresponding parts throughout the several views, FIG. 1 is a schematic showing the fabrication of the nanofiber carried out in an enclosed and environmentally controlled chamber 1. An electrically insulating filter frame 6 with a coarse support mesh 7 (i.e., a secondary electrode) is placed on a filter assembly holder 41-43. Completing the circuit is a ground electrode 43 which is connected to ground by a conducting tube 28. The mesh 7 functioning as support for the electrospun materials has macroscopic openings that in one non-limiting example are about 1.4 mm by 1.4 mm and that contributes minimally to the pressure drop across the filter, yet provides structural support for the nanofibers. The mesh in this example is made from wires having a diameter of 0.1 mm. Carbon dioxide CO₂ process gas 26 is introduced into the chamber 1 with the humidity of the chamber controlled to between 20% and 40% RH using a mixture of dried CO₂ and humidified CO₂. A polymer solution (e.g., 21 wt % polysulfone in solvent dimethylacetamide) from reservoir 3 flows to electrospinning emitter/orifice 2, which is connected to high voltage power supply 5. An electric field present at the end of the orifice 2 extracts the polymer solution from the orifice forming fibers of the polymer solution.

The structure of the electric fields between the emitter 2 (powered by supply 5) and ground, which drives fiber deposition, are controlled, in part, by the design of the filter frame holder 41-43. Furthermore, the potential of the support mesh 7 is controlled by an electric field pulsation device 9 (i.e., a voltage limiter or discharge device or an electric field applicator device). The electric field pulsation device 9 is configured to pulse an electric field at the collector at least once (or frequently) during electrospinning of the fibers to discharge charge accumulated on the electrospun fibers.

The electrospun fibers 8 carry charge to the mesh (i.e., the secondary electrode 7) which is discharged frequently to the grounded primary electrode 43 by the voltage limiter device 9 acting in this example as an electric filed pulsation device. The resultant electric field in one embodiment of the present invention is oriented in the direction of the spinning fibers and dynamically modifies the structure of the electric field, thereby according to the present invention imparting improved fiber and mat properties (as measured by the FoM of the mat) as compared to the static field electrospinning conventionally used in which collector 7 would for example be grounded.

In one embodiment of the invention, a jacket of CO₂ gas 26A flows over emitter 2. A jet of polymer fibers 8 is formed that travels towards the filter assembly and holder. Polysulfone PSu fibers (for example) electrospun onto coarse mesh 7 typically have an average fiber diameter of less than 200 nm. The filter mat 12 formed by the nanofibers can be about 3 μm thick, therefore containing on the order of 5-20 nanofiber layers. At least part of the process gas flows through the filter mat during the deposition process.

In one embodiment of the invention, the pressure drop across the forming nanofiber filter can be monitored real-time during fabrication. Many factors affect the resultant filter performance. Some of these factors are: obtaining a suitably small nanofiber size, a suitable nanofiber mat morphology, and a filter frame+nanofiber mat construct that provides rigidity to the resultant composite so that the support structure does not limit the pressure drop.

A wide range of polymers have been electrospun in the literature including polycarbonate, polyamides, polystyrene, and polysulfone as a few examples. For instance, polysulfone (Psu), M_{w}˜35,000 g/mol, can be spun from a 21 wt % solution in N,N-dimethylacetamide (DMAc), and polycarbonate, M_{w}˜60,000 g/mol, can be spun from a 15 wt % solution of polymer in a 50/50 solution of tetrahydrofuran (THF) and N,N-dimethyl formamide (DMF).

U.S. Pat. Appl. Publ. No. 2005/0224999, the entire contents of which are incorporated herein by reference, describes the use of an electronegative gas to facilitate the electrospinning process by the introduction, for example, of carbon dioxide (CO₂) around the spinning orifice or emitter. Gases such as CO, CF₄, N₂O, CCL, CCl₃F, CCl₂F₂ and other halogenated gases can be introduced into the electrospinning environment at 26A and/or 26B. The electronegative process gas stabilizes the Taylor cone formed by the polymer jet as it comes off the needle, reduces corona discharge at the needle, and reduces fiber diameter. Furthermore, spinning in a controlled environment ensures less contamination of the fibers, improves safety, and adds another dimension of control parameters that can be used to fine-tune fiber formation.

In one embodiment of the invention, an electronegative gas 26A flows coaxially with the spinning needle along with use of a controlled gas environment. Typically, a gas shroud is used to provide the coaxial gas flow. A typical shroud used in the present invention can be in the shape of an annulus having an outside radius of about 0.48 cm and an inside radius of about 0.40 cm. A variety of geometries and sizes are possible; such as for example a circular outside with a hexagonal inside being an additional geometry. In the annular geometry, a distance from an exit end of the annulus where gas is emitted to the tip of the electrospinning element can range from flush (0 cm) to 8 cm; with a typical distance being around 4 to 5 cm, and with the distance being 4.7 cm for the detailed examples later.

In one embodiment of the invention, control of the electrospinning conditions can produce polymer nanofibers with an average fiber diameter AFD of 100 nm and less with standard deviations less than 52% of the AFD. Nanofibers less than 200 nm have been found to improve the filtration properties. Media produced with AFD=80±30 nm with few defects (beaded fibers and microholes) have shown superior performance with FoMs greater than 30 kPa⁻¹ for non-electret media and greater than 45 kPa⁻¹ for electret media.

In one embodiment of the invention, additives in the polymer solution can make a substantial difference in fiber size and quality. Addition of trace amounts of a salt or a surfactant increases the solution conductivity and hence the charge accumulation at the tip of the electrospinning element resulting in larger stretching forces applied to the forming fiber, hence smaller diameter fibers. The surfactant also reduces the surface tension of the polymer allowing for even smaller fibers to be spun. Lithium salts, (for example, lithium chloride and lithium triflate) or surfactants such as tetra butyl ammonium chloride (TBAC) are suitable for the invention. Lithium salt concentrations from 0.005 to 3 wt % are suitable for the present invention. Concentrations of TBAC of between 0.06 and 0.4 wt %, were exemplary, although other concentrations are suitable.

In one embodiment of the invention, polymer concentration in the electrospinning solution impacts the quality of the electrospun fibers. Concentrations from 17 wt % to 30 wt % for the molecular weight of PSu are suitable for the present invention with around 21 wt % typically being ideal.

In one demonstration of the invention, Udel P3500 LCD PSu made by Solvay Advanced Polymers was used. The molecular weight is in the range of 22,000 to 36,000 g/mol. Molecular weight is understood as an important component in formulating the polymer solution. The P3500 LCD contains few cyclic dimmers and is suitable for many of the applications described herein. However, the invention here is only exemplified by this polymer and its characteristics, and is not restricted to this particular polymer.

In one embodiment of the invention, stainless steel extrusion tips from 0.15 mm to 0.59 mm internal diameters (ID) are suitable for the present invention. Larger and smaller diameters may also be used. In another embodiment of the invention, Teflon™ capillary tubes with ID from 0.076 mm to 0.31 mm are suitable for the present invention. Larger and smaller diameters may also be used. Both types of orifices can produce small fibers. For both orifices, low flow rates of the polymer solution (e.g., 0.05 ml/hr) coupled with high voltage drops typically resulted in the smallest fiber diameters (e.g., AFD less than 100 nm). In both cases, the voltage was set to 22 kV to 30 kV for a 17.8 cm to 25.4 cm gap (i.e., distance between emitter 2 and mesh 7). Of note is that the voltage per electrospinning-gap is one parameter determining the pulling strength; this gap also determines a travel time thus partly determining fiber stretching time.

Besides stainless steel and Teflon™ extrusion tips, in the invention, other materials (provided the materials are non-reactive with the substance being electrospun including any solvent used in the electrospinning process) can be used such as for example polymers, glass, ceramic, or metal extrusion tips.

In one embodiment of the invention, the relative humidity RH of the electrospinning chamber effects fiber morphology. For example, when using 21 wt % PSu (M_{w}˜35,000 g/mol) in DMAc, a high RH (e.g., >65%) resulted in fibers that have very few defects and smooth surfaces but larger diameters. A defect in a fiber is in general seen as a deviation from a smooth round fiber of long length. Defects thus are beads on the fiber, variations in fiber diameter in the axial direction, etc. One practiced in the art of fiber spinning will know this. A low RH (e.g., <13%,) resulted in smaller fibers but more defects. Modestly low RH (e.g., 40% to 20%) typically produced small fiber size with fewer defects.

A variety of mechanisms are suitable in the invention to control the chamber RH such as placing materials that absorb (e.g. calcium sulfate) or emit water moisture (e.g., hydrogels), operating a small humidifier in the chamber, and adding moisture into the process gas streams 26 prior to introduction to the electrospinning chamber. For example, positive results were obtained by bubbling CO₂ through deionized (DI) water and then introducing the humidified CO₂ gas into the chamber. In one embodiment of the invention, two gas streams (e.g., one humidified and one dry) are used to obtain a desired RH for the chamber and/or for the gas jacket flowing over the electrospinning orifice.

In another embodiment of the invention, RH and electrospinning conditions are used to vary the fiber diameter as a function of time thus providing for the creation of a nanofiber mat that varies in fiber diameter in the thickness direction of the mat.

Various embodiments of the invention prepare nanofibers using 21 wt % PSu (M_{w}˜35,000 g/mol) in N,N-dimethylacetamide (DMAC) solution with the solution containing 0.2 wt. % of the surfactant TBAC, which lowers the surface tension and raises the ionic conductivity and dielectric constant of the solution. The above-noted polymer solution can be spun from a 300 (ID≈0.1524 mm) stainless steel needle with a flow rate of 0.05 ml/hr of the polymer solution to the stainless steel needle, a gap of 25.4 cm between the needle and the collector was set, an applied potential of 29.5 kV DC was used, a CO₂ gas jacket flow rate of 6.5 L/min was used, and RH can be controlled to be in the range of 22 to 38%.

The nanofibers produced by the invention include, but are not limited to, acrylonitrile/butadiene copolymer, cellulose, cellulose acetate, chitosan, collagen, DNA, fibrinogen, fibronectin, nylon, poly(acrylic acid), poly(chloro styrene), poly(dimethyl siloxane), poly(ether imide), poly(ether sulfone), poly(ethyl acrylate), poly(ethyl vinyl acetate), poly(ethyl-co-vinyl acetate), poly(ethylene oxide), poly(ethylene terephthalate), poly(lactic acid-co-glycolic acid), poly(methacrylic acid) salt, poly(methyl methacrylate), poly(methyl styrene), poly(styrene sulfonic acid) salt, poly(styrene sulfonyl fluoride), poly(styrene-co-acrylonitrile), poly(styrene-co-butadiene), poly(styrene-co-divinyl benzene), poly(vinyl acetate), poly(vinyl alcohol), poly(vinyl chloride), poly(vinylidene fluoride), polyacrylamide, polyacrylonitrile, polyamide, polyaniline, polybenzimidazole, polycaprolactone, polycarbonate, poly(dimethylsiloxane-co-polyethyleneoxide), poly(etheretherketone), polyethylene, polyethyleneimine, polyimide, polyisoprene, polylactide, polypropylene, polystyrene, polysulfone, polyurethane, poly(vinylpyrrolidone), poly(2-hydroxy ethyl methacrylate) (PHEMA), gelatin, proteins, SEBS copolymer, silk (natural or synthetically derived), and styrene/isoprene copolymer.

Additionally, polymer blends can also be produced as long as the two or more polymers are soluble in a common solvent or mixed solvent system. A few examples would be: poly(vinylidene fluoride)-blend-poly(methyl methacrylate), polystyrene-blend-poly(vinylmethylether), poly(methyl methacrylate)-blend-poly(ethyleneoxide), poly(hydroxypropyl methacrylate)-blend poly(vinylpyrrolidone), poly(hydroxybutyrate)-blend-poly(ethylene oxide), protein blend-polyethyleneoxide, polylactide-blend-polyvinylpyrrolidone, polystyrene-blend-polyester, polyester-blend-poly(hyroxyethyl methacrylate), poly(ethylene oxide)-blend poly(methyl methacrylate), poly(hydroxystyrene)-blend-poly(ethylene oxide)).

### Filter Support Mesh

Filters have been formed on meshes that contained 1.27 cm, 0.635 cm, or 0.159 cm (i.e., American Engineering standard sizes: ½″, ¼ and 1/16″ respectively) openings using copper, brass, nickel, stainless steel, and aluminum metal are suitable for the present invention. Aluminum window screen with openings about 1.2 mm×1.6 mm is also an acceptable support. The surface of the metal mesh, especially for aluminum meshes, is cleaned to remove dirt and oils followed by washing the mesh in diluted sulfuric acid (10 to 20% H₂SO₄ in DI water by volume) to remove resistive oxides and impurities. This cleaning improved nanofiber dispersion and adhesion. Any number of metals or metal alloys, with openings of various shapes (square, rectangle, circular, diamond, oblong and odd shaped), with openings ranging in size from about 12.7 mm down to 1000 times the AFD can be used in the present invention.

Adhesion of the nanofibers to the support mesh in one embodiment of the invention is improved via the application of an adhesive to the mesh directly prior to electrospinning. The adhesive typically is a slow drying adhesive permitting the adhesive to be tacky (i.e., adhesive) when electrospun fibers are deposited. Alternately, in another embodiment the wires (or components) of the mesh can be coated with a very thin layer of polymer that has surface groups which interact (van der Waals, hydrogen-bond, dipole, electrostatic attraction, etc.) with the polymer fibers being deposited on the mesh. One example system is a thin coating of poly(glycidyl methacrylate) (PGMA) on nickel mesh with nanofibers of poly(methyl methacrylate) (PMMA) deposited on the coated mesh. An alternate embodiment of the invention uses cross linkable systems that are polymerized after the fibers are deposited. Examples include chitosan nanofibers crosslinked with glutaraldehyde and polyvinyl acetate crosslinked with borax; also, deposition of nanofibers on adhesives such as Norland's line of curable adhesives based on mercapto-ester compounds. These surface coatings increase adherence and adhesion of the nanofibers to the support.

In another embodiment of the invention, the metal mesh is replaced with metal foams such as ERG's Duocel™ metal foams; for example, Aluminum Durocel with 20 pores per inch (PPI; alternately an average pore size of 1.27 mm). Foams can also be made with copper, nickel, and various other metallic as well as polymeric materials. Porosities ranging from 10 PPI (2.5 mm pores) to 40 PPI (0.064 mm pores) are acceptable for the invention.

In one embodiment of the invention, aluminum parts (or other metals that oxidize) are treated to prevent formation of aluminum oxides (metal oxides), for example using the process known as “Electroless Nickel” or electroplating with gold.

In yet another embodiment of the invention, the support mesh is composed of a plastic that is conductive. For example polyester or nylon screen (or coarse nonwoven polymer mesh) is coated with a conductive finish such as gold, palladium, or various metal alloys. The coating process can be achieved by any number of established arts including vacuum deposition (e.g., sputter coating, evaporation deposition, and chemical vapor deposition), and chrome plating of plastics. Alternately, the mesh can be composed of conductive plastic that obtains its conductivity via embedded conductive particles (carbon nanotubes, metals etc.); or, any method to make plastic mesh conductive, semi-conductive, or electrostatic dissipating.

In one embodiment of the invention, a nonwoven support that is conductive or made conductive (e.g., sputter coating etc., as mentioned above) is used. The nonwoven support will make a larger contribution to the pressure drop but may be acceptable in certain applications. This embodiment is similar to existing art but differs in that firstly a conductive nonwoven is used and secondly—and most importantly—the structure of the electric fields and electric potential of the support is controlled differently versus existing art as detailed later in this document.

In one embodiment of the invention, utilizing the advantageous properties of the high FoM nanofiber mats (described later), nanofibers of the invention are deposited on a substrate of conventional filter media, which is supported by the metal mesh during spinning. The layered nanofiber conventional filter media thus created can be later removed from the mesh and pleated, bonded into bags, and used in related conventional fabrication techniques for making various filter products. This embodiment is similar to existing art but allows control of the structure of the electric fields and electric potential of the support mesh is controlled differently versus existing art to make media with FoM greater than 20 kPa⁻¹. Additionally, due to the nature of electrospinning, the fibers could be spun directly onto a pleated filter or other filter product (e.g. bag filter) providing for enhancement of a low efficiency filter. One such example would apply a layer of nanofibers to a pleated general ventilation filter which would improve removal of allergens (pollen, endotoxins, etc) or biotoxins (endotoxins, spoors, infections agents, etc.).

In one embodiment of the invention, polymers may be selected to dissolve in water, pH and/or regulated buffer solutions, degraded by heating to above room temperature, or degraded by enzymes to facilitate recovery of particles or bioaerosols for subsequent analysis, in the case where the nanofiber mat is used for sampling.

### Filter Fabrication and Nanofiber Mat Morphology

As mentioned above, one way to assess filter performance and compare different filters is to use figure of merit (FoM) comparisons. The FoM is a fundamental measure of a filter that allows comparison of filters of different thicknesses to be compared; the greater the FoM the better the filter.

Fundamentally, the FoM is a ratio of the individual fiber collection efficiency normalized by the individual fiber aerodynamic drag. A simple way (but not necessarily the only way) to understand FoM is as follows: if one takes two identical filters and place them in series, the efficiency of the system increases, but the pressure drop increases as well because the thickness was doubled. Therefore, the FoM stays constant. A particularly interesting aspect of fibrous filters and FoM is that the majority of commercial fibrous filter media all have similar FoMs. A FoM of about 12±2 kPa⁻¹ for 0.3 μm particles at a face velocity of 5.33 cm/s describes the performance of nearly all fibrous fiberglass media over a wide range of efficiencies.

Theoretically, the FoM depends on the fiber diameter and a packing density of the filter. For a packing density of 0.09 and a fiber diameter of 10 nm (potentially a lower limit for practical spinning of fibers), the FoM is computed to be 720 kPa⁻¹ for 0.3 μm particles at 5.3 cm/s. These computations were based on equations for pressure drop and particle collection reported by Payet et al (1992) and Thomas et al (1992) incorporated by reference.

Although modeling of filter FoM as a function of fiber diameter predicts marked improvement of filter performance with decreasing fiber diameter, this improvement has not been realized. In prior work, filters have been formed by electrospinning nanofibers on grounded supports or substrate (e.g., low efficiency cellulose filter media) sitting on a grounded surface. However large enhancement in FoM were not observed, that is the FoM obtained was less than 12 kPa⁻¹ for 0.3 μm particles at 5.3 cm/s. Therefore, using electrospun nanofibers to obtain high efficiency filters with improvement over existing technologies is not straightforward and has not been heretofore realized.

Producing a nanofiber filter with improved performance over existing technology involves typically both sub 200 nm fibers and appropriate filter mat morphology (e.g., area-wide uniformity and fibers having a variance in average fiber diameter that is comparable to the average fiber diameter). Obtaining a filter mat morphology suitable for a high FoM filter involves factors such as the thickness of the nanofiber filtration layers, the packing density of the fibers or filter solidity (solidity=1-void volume), the average fiber diameter, and the range and population of fiber diameters.

Solidity is difficult to measure, especially for nanofiber media. However, a common metric in the art of nonwoven media is basis weight, or mass of material per area of media (g/m²); this basis weight is proportional to the thickness and solidity of the media. Typical polymer spun-bound nonwoven media of low to modest efficiency range in basis weight from 13 g/m² to 280 g/m². Typical fiberglass media of modest to high efficiency ranges in basis weight from about 65 g/m² to 78 g/m². For the polymer nanofiber mat (excluding support mesh) of our electrospun media the basis weight for moderate to high efficiency media ranges from about 0.7 g/m² to 5 g/m².

The specific pressure drop of a filter media is defined as the slope of the plot of pressure drop versus face velocity, where face velocity is gas flow rate divided by filter area. An empirical relation between pressure drop and face velocity in terms of the above mentioned filter media parameters is given by:

$$Δ P = [ \frac{16 μ h {α}^{3 / 2}}{{R}_{f}^{2}} ] {U}_{0}$$

where μ is gas viscosity (a constant), h is media thickness, α is media solidity, R_{f} is radius of filter-fiber, and U₀ is face velocity. Therefore the specific pressure drop is proportional to thickness and solidity and inversely proportional to fiber diameter and partly describes the structure of the filter media. Typical fiberglass HEPA media have specific pressure drops (slopes) over 50 Pa s/cm. The nanofiber media of this invention have specific pressure drops in the range of 6 to 35 Pa s/cm. This range of values occurs due to the afore mentioned fiber size, size distribution, thickness, solidity, and media defects (beaded fibers and microholes).

The filer media structure is thus defined in one illustrative way by the AFD, size distribution, basis weight, and corresponding specific pressure drop. The FoM and penetration is thus the result of this nanofiber structure and the use of a low pressure drop support such as, but not limited to, aluminum window screen.

Filter FoM can also be affected, in part, by leaks at component interfaces, mat uniformity across the entire support mesh, and mat morphology (fiber packing density, fiber diameter, etc.). In one embodiment of the invention, fabrication of a filter (or filter media) may involve the attachment of the coarse mesh 7 to a supporting frame 6. One issue is selection of an attachment scheme that prevents the formation of leaks at the mesh/frame interface due to inadequate deposition of the nanofibers. In one embodiment of the present invention, an adhesive is used. In this embodiment, fibers are deposited under similar conditions as used for nanofiber deposition on a plain support mesh, but the presence of an adhesive improves sealing of the nanofiber mat to frame. In another embodiment, the interface is sealed or further sealed with an adhesive that is compatible with the polymer nanofibers (adheres to the polymer nanofibers, mesh, and frame without dissolving the nanofibers) such that a weakened nanofiber/adhesive interface is not formed.

Various adhesives such as a silicone rubber, epoxies, and high voltage electrical tape as sealing means have been used in the present invention. A combination of the adhesive dielectric strength and the surface properties of the adhesive (surface chemical groups and charge) determine how the electrospun nanofibers interact with the adhesives. Polystyrene and PSu fibers were found to readily deposit on common epoxy adhesives while they were less likely to deposit on common silicon adhesives such as Electric Products, Inc.'s Plumber's Goop™ and Dow Corning's RTV™. The smallest amount of fiber deposition was found for Plumber's Goop and 3M high voltage electrical tape.

In one embodiment of the invention, epoxy (e.g., Loctite™ Epoxy gel) is applied to ensure good coverage of PSu nanofibers at the interface of the support mesh and the frame. In another embodiment of the present invention, this same epoxy is used after electrospinning PSu to seal leaks and thin spots. Other embodiments that use polymer(s) different from PSu would require selection of adhesive such that adhesive/polymer nanofiber compatibility is maintained.

In another embodiment of the invention, adhesives are selected to minimize fiber deposition in certain areas of a filter geometry. For example a combination of mesh shape and voltage potentials along with adhesives that have low or high fiber deposition properties could be used to create complex two or three dimensional patterns of nanofibers.

Although various embodiments include the support mesh being attached to a frame, other embodiments of the invention do not require a frame supporting the mesh.

In one embodiment of the invention, a voltage discharge device or a voltage limited device (VLD) is provided which regulates the mesh potential as a function of time. These devices are examples of the above noted electric field pulsation device. Methods for controlling the voltage of the mesh/forming nanofiber mat include, for example, a spark gap device or voltage discharge tube. Once the mesh/mat reaches a limiting value, charge is removed. The VLD thus prevents stoppage of the electrospinning process.

One embodiment of the VLD of the present invention is a spark gap device, i.e., element 9 in FIG. 2, which was formed by folding excess support mesh under the plane of the support mesh where the fibers will be deposited. The distance between the tips of the wires to the ground plate 41 below them was about 3.5 mm. The voltage at which discharge occurs is the dielectric breakdown voltage, which is controlled by the gap distance (e.g., 3.5 mm) and the dielectric breakdown voltage of the gas in the electrospinning chamber. The dielectric breakdown voltage of the gas is determined by the gas composition and environmental conditions (i.e., RH and temperature).

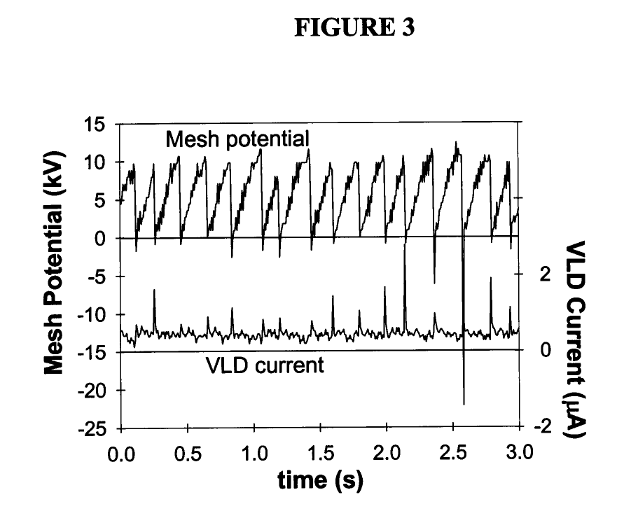

The support mesh potential varies with time as determined by the VLD 9 and electrospinning conditions. This time varying potential is beneficial in the production of high FoM filters. FIG. 3 provides an example of the support mesh potential and the discharge current/VLD current as a function of time. The mesh potential was measured using a high impedance probe; discharge current was measured across a resistor positioned in series between the ground plate system and earth ground. For an applied spinning potential of 29.5 kV, the arithmetic average of the mesh 7 potential was about 5.7 kV and the frequency of discharge was 5.3, 1.0 Hz, the peak voltage was around 10 kV. The time varying mesh potential and its average value are exemplified by FIG. 3 but not restricted to these values. Other frequencies and potentials are suitable for the invention. Indeed, in one embodiment of the invention, layers of nanofibers are deposited in the presence of a periodic discharge to ground. In another embodiment of the invention, layers of nanofibers are deposited in the presence of an applied electric field pulsation.

In one embodiment of the invention, the abruptly varying waveform produces fiber mats with improved filtration properties, as measured by the resultant FoM values obtained.

This route of fiber fabrication using abrupt electric field modulation could be applied in other embodiments of the present invention to the fabrication of nanofibers, nanofiber yarns, nanofiber nonwovens, and other nanofiber structures for a variety of applications beyond the forming of filtration media and devices.

The invention is not limited to the exact abrupt transitions shown in FIG. 3. Nevertheless, the transitions in FIG. 3 represent an illustrative example. The abrupt discharge events seemed to typically take 16 ms to discharge 10 kV. However, these numbers are not fixed even for the transitions shown in FIG. 3. Similarly, the charging time back to the 10 kV was around 200 ms but also varied from cycle to cycle.

In one embodiment of the invention, the applied waveforms or the charging events (for example up to 15 000 V or 50% of applied voltage) can take from 100 ms to 1 sec with 200 ms being typical. Discharging events or abrupt transitions to a near zero electric field potential can occur quickly, for example taking 2 ms to 80 ms with 16 ms being typical. The values and waveforms shown in FIG. 3 are taken to be representative abrupt transitions that can be used, according to various embodiments of the present invention to produce fiber mats for various nanofiber applications.

A number of methods for controlling the mesh potential with a VLD are possible in the present invention. A spark gap device can be used that is not an integrated part of the support as shown in FIG. 2, but rather simply connects to the filter mesh. This gap can be carefully controlled using a micrometer like device. The gap can also be dynamically controlled, that is the time varying potential of the mesh is monitored and gap size adjusted to actively control the mesh potential behavior to a desired value. The VLD can be any number of devices that sets a defined voltage or time-varying wave form such as gas discharge tubes (e.g. SRC's voltage limiting gas discharge tubes), miniature neon lamps, switches, or other electronic components or systems that either actively or passively regulate the voltage of the mesh as a function of time.

Embodiments of the invention include VLD and electrospinning conditions such that frequency can range up to 1000 Hz and the average mesh/mat potential can range from 0 V to 15 000 V or 0 to 50% of the voltage applied to the electrospinning orifice. Other embodiment of the present invention can apply similar voltage waveforms at these magnitudes and frequencies.

In addition to the electrical potential of the support mesh 7, the shape (or structure) of the electric fields were important to the fiber formation process. While the mesh 7 is kept at a regulated voltage potential the presence, location, and shape of grounded metallic electrodes were important. While circular or cylindrical components have been used, other geometries are possible.

In one embodiment, a ground plate was positioned at a set distance below the mesh 7 in order to provide sufficient potential difference and shape of the electric fields needed to obtain adequate electrospinning and deposition of the fibers on the mesh. In another embodiment of the present invention, a second ground plate was positioned below the support frame 6 with some amount of the metal ground plate extending beyond the side of the frame 6. This further helps to maintain adequate electrospinning potential and electric field shape to promote deposition of the fibers onto the mesh, including to the top edge of the filter frame 6. In another embodiment of the invention, a gas discharge tube or other VLD is used such that no gap distance is specified/used.

RH was also found to affect deposited nanofiber mat morphology (already mentioned above was the effect on fiber morphology). Higher RH resulted in fibers being deposited in stronger registry with the wires of the mesh while lower humidity gave more uniform dispersion of fibers across the mesh openings. For the PSu example already mentioned, an RH in the range of 38% to 22% tended to yield better fiber morphology. The RH control technology is the same as mentioned above in the discussion of forming nanofibers.

The thickness of the nanofiber mat can vary from about 0.25 μm (250 nm) to 500 μm or beyond if needed, where most filters had an average mat thickness in the range of 2 to 5 microns. The average mat thickness numbers represent the average thickness of the total nanofiber mat in a filter. Alternately the mat thickness can be defined as layers of nanofibers with the thickness including from 4 to 4000 layers where 4 to 400, or 5 to 100, or 5 to 15 layers were typical in various embodiments.

### Various Methods of the Invention

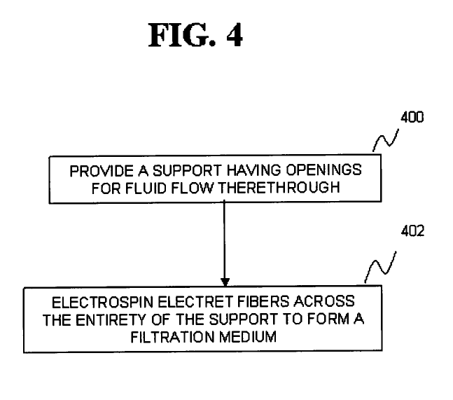

Returning now to a general discussion of the processes in FIG. 1-3, FIG. 4 illustrates a method according to one embodiment of the invention for forming a fiber mat. At 400, a support having openings for fluid flow therethrough is provided. At 402, electret fibers are electrospun across an entirety of the macroscopic openings to form a plurality of layers providing a filtration medium in which particles entering the layers are filtered from the fluid flow. Nanofibers having an average fiber diameter less than 200 nm are particularly suited for high FoM filtration. In one particular embodiment of the present invention, at 402, an electric field is pulsed at the collector at least once during electrospinning of the fibers to discharge charges accumulated on the electrospun fibers. The pulsation can come from one of the above-described voltage discharge devices or can be externally impressed. For example, in one embodiment of the invention, a time varying waveform (similar to that shown in FIG. 3) can be impressed on the support. Waveforms such as square waves and sawtooth waves are also appropriate for the present invention.

At 400, the support can be a conductive mesh. An adhesive can be applied to a perimeter of the support to seal the perimeter from particle by-pass of the filter. The conductive mesh can be treated and coated to promote adhesion of nanofibers to the mesh. The support in one embodiment of the present invention is incorporated into the filter.

As such, a filtration medium of the present invention can include a number of support media ranging from rigid structures with macroscopic openings to high efficiency particulate air (HEPA) filter medium. As such, the present invention permits in one embodiment the formation of a high performance filter by electrospinning nanofibers directly onto existing lower efficiency medium such as conventional residential and commercial building filters having a minimum efficiency reporting value (MERV) ranging from 3-12.

MERV ratings are determined for general ventilation filters as described in ASHRAE Standard 52.2 (1999). A potassium chloride aerosol (KCl) challenge is used to obtain particle size dependent efficiency over a wide range of particle diameters. Pressure drop and filter efficiency are the two main criteria when testing a filter. The determination of pressure drop is a function of gas flow rate while the measurement of filter efficiency at the rated flow rate is a function of particle diameter from 0.3 to 10 μm. The initial efficiency as a function of particle diameter is determined with the KCl aerosol and an Optical Particle Counter. The efficiency is determined with the following steps. The efficiency of the clean filter is measured. Then, a conditioning step with ASHRAE dust is conducted to simulate atmospheric exposure to particles on permanently charged filters and the resulting reduction in efficiency. The efficiency as a function of particle diameter measurement with KCl aerosol and OPC(s) is repeated. The filter is then loaded with ASHRAE dust in 4 different increments followed by efficiency as a function of particle diameter measurements using the KCl aerosol and OPC(s). The final dust loading will cause the pressure drop in the filter to match the manufacturers stated pressure drop limit. The minimum efficiency reporting value (MERV) is determined by first computing the average of the minimum efficiency observed in the three particle size ranges 0.3 to 1, 1.0 to 3.0 and 3.0 to 10.0 μm. A standard table in ASHRAE (1999) is used to look up the MERV corresponding to the minimum efficiencies.

In other applications of the invention, the nanofibers would be electrospun onto the filter media used in making pleated filters and other engineered filter units. Such an approach for example would be one practical way to form an improved filter in which the nanofiber coated filter media would be then pleated and formed into a conventional-shaped HEPA filter unit for installation into standard air handlers. In another example HEPA media could be coated with nanofibers to produce filters with previously unreachable efficiencies (>99.9999%) with tractable pressure drops.

In another embodiment of the invention, the support for deposition of the fiber mats of the present invention can be removed or dissolved from the deposited fiber mat, permitting the fiber mat to be transferred to another filtration medium such as for example a conventional filter medium, a plastic foam, a metallic foam, a semi-conductive foam, a woven material, a non-woven material, a plastic screen, and a high efficiency particulate air (HEPA) filter.

The mesh is typically conductive but could be insulating when used in conjunction with a conducting frame during electrospinning. The support can have conical shaped support, a circular shaped support, a planar shaped support, a spherical shaped support, or a cylindrical shaped support. The support can be shaped as a mold such as for example to fit a respirator cartridge. The support can include multiple cellular frames arranged adjacent to each other. As such, electrospinning in each frame provides a mechanism for obtaining a larger area filter with suitable particle entrapment and filtration in each frame.

At 402, the electrospinning can form nanofiber layers with respective ones of the nanofibers in one layer integrally attached to other nanofibers in an adjacent layer. The electrospinning can electrospin a solution including a polymer dissolved in the solution, e.g., having a concentration of 1 to 50 wt % in the solution in some embodiments and 17 to 30 wt % in the solution in other embodiments. Electrospinning can also be performed with molten polymers. The polymer can have a molecular weight of 20,000 to 2,000,000 g/mol. Alternative polymer concentrations and polymer weights can be mixed with appropriate solvents and used for the electrospinning process.

The electrospun nanofibers can have an average fiber diameter of less than 500 nm, or less than 200 nm, or less than 100 nm, with standard deviations, as percent of AFD, of less than 52%, less than 45%, or less than 40% depending on the specific electrospinning conditions employed, as shown above. The electrospinning can electrospin first nanofibers having a first average fiber diameter; and thereafter electrospin on the first nanofibers second nanofibers having a second average fiber diameter smaller than the first average diameter. In this manner, a progressively finer mesh of the nanofiber filter mat is obtained. The electrospinning can electrospin first nanofibers having a first average fiber diameter; and thereafter electrospin on the first nanofibers second nanofibers having a second average fiber diameter larger than the first average diameter. In this manner, a progressively larger mesh of the nanofiber filter mat is obtained. At 402, the electrospinning can form between 4 to 4000 (or 10 to 100) layers of nanofibers. The resulting electrospun nanofiber mat can have a basis weight of less than 5 g/m², or less than 3 g/m², or less than 1 g/m². The resulting specific pressure drops can range from 6 Pa s/cm to 35 Pa s/cm.

Further, the resultant fiber mat (with or without the support) can be provided with a filtration medium disposed adjacent to the fiber mat or the support. The base filtration provides coarse filtration of particles (e.g., filtration of particles larger than 1 micron). Alternatively, the method can assemble plural of the supports, with respective ones of the supports including the nanofiber layers, thereby providing multi-stage filtration.

At 402, a controlled atmosphere for the electrospinning can be provided by controlling a humidity or solvent concentration in the atmosphere. The humidity can be controlled to a relative humidity less than 100% or in some embodiments between 5% and 65%, or in other embodiments between 15 and 40%. The solvent concentration can be controlled less than a saturation amount to a relative concentration (e.g., partial pressure) between 10 and 80% of the atmosphere in the enclosure and more specifically between 20 and 45%. At 402, the electrospinning can electrospin a pH sensitive polymer substance, thereby permitting in some cases dissolution of the electrospun fibers after particle entrapment. At 402, the electrospinning can electrospin a thermally sensitive polymer substance or an enzyme sensitive polymer substance, also permitting in some cases dissolution of the electrospun fibers after particle entrapment.

At 402, the electrospinning can provide an additive including at least one of a salt and a surfactant to a substance to be electrospun. The additive can be supplied at a concentration of 0.01 to 10% or higher and in various embodiments at a concentration from 0.06 to 0.2 wt %. At 402, uniformity of fiber deposition is improved by generally moving the electrospinning element (i.e., a spinneret) and support relative to each other.

At 402, the electrospinning can detect an amount of gas or aerosol passing through a portion of the filter being tested, and translate the electrospinning element or provide relative motion between the electrospinning element and the collector in response to a result of the detecting. Light scattering techniques can also be used for the detection of mat uniformity.

At 402, the electrospinning can produce an electret filtration medium in which charge from the electrospinning process is retained in the filtration medium. However electret filters can be unreliable under certain use conditions such as loss of charge due to exposure to organic vapors or high heat and humidity or as a result of covering up the charge with dust or fine particles. Potentially an active electrostatic collection system could be made by layering conductive and insulating nanofiber mats and placing a potential across them. Cost and manufacturability may limit the markets where the media could be used. However, the present electret filters show considerable improvement over conventional electrets filters.

As described above, fibers such as nanofibers are electrospun in a controlled gas environment, as depicted in FIG. 1, onto a coarse mesh or nonwoven material that contributes minimally to pressure drop and filtration. The fibers deposit as a mat thus forming a filtration media. The collection mesh or support for the collection mesh (i.e., a nonwoven sitting on top of a conductive plate, mesh, or other support-like material) that the fibers deposit on is floating relative to ground in one state and grounded in another state. In the invention, the potential and therefore the field at the collector is abruptly varied with time. One possible configuration and wave form are shown in FIGS. 2 and 3. This abruptly varying field on the collector for the fibers imparts substantially higher charge on the fibers than if the collector was grounded.

As described above in relationship to eqn. (1), one method of describing collection efficiency per filter pressure drop is to measure the penetration (Pt) of a particular sized aerosol particle at a specified face velocity and record the associated pressure drop (ΔP). The filter figure of merit (FoM) is thus,

$$FoM = \frac{- log ( Pt )}{Δ P} .$$

For 0.3 μm diameter particles at a filter-media face velocity of 5.3 cm/s, FoM=12±2 kPa⁻¹ for typical commercial flat fiberglass HEPA media.

The media composed of electrospun nanofibers using the abruptly field changing process of the invention has average fiber diameters (AFD) in the range of 70 to 150 nm with standard deviations (SD) in the range of 25 to 100 nm with typical values being AFD=80 to 100 nm and SD=30 to 60 nm. The filter performance (FoM) is determined by the combination of AFD, SD, size distribution of the fibers (e.g., log normal), amount of defects (beads and beaded fibers per volume of media), filter-media thickness, and filter solidity (solidity α=1-void volume of filter media).

One way to specify filter structure and performance is to consider the AFD, SD, media mass per area, flow resistance (pressure drop per velocity), and resulting media efficiently. (Note: FoM succinctly describes collection efficiency pre pressure drop across any thickness or type of filter media). A plot of pressure drop versus face velocity for these electrospun-nanofiber materials has a slope in the range of 6 to 35 Pa s/cm where the range of values occurs due to the afore mentioned fibers size, size distribution, thickness, and solidity. Typical fiberglass HEPA media have slopes over 50 Pa s/cm.

Thus, a combination of AFD, size distribution, weight basis and resulting FoM describes and measures the structure and resulting performance for air filtration media of the filters of the invention. The performance obtainable by the nanofiber media here is not obtainable via conventional methods and exceeds the performance of nanofiber media in the academic, commercial, and patent literature.

### Comparative Example

Comparison of collection enhancement with spark gap. Polysulfone UDEL 3500 LCD from Solvay Advanced Polymers (Alpharetta, Ga.) is dissolved in dimethylacetimide to a concentration of 21 wt % with 0.201 wt % tertbutyamoniumchloride (TBAC) ionic surfactant. The method of electrospinning disclosed in U.S. Ser. No. 11/559,282 and U.S. Pat. No. 7,297,305 was used. An enclosed environment of carbon dioxide with an RH of 30% and temperature of 21° C. is used with a 25.4 cm gap and 30 kV potential to electrospin the polymer solution from a blunt 30 G needle. The fibers were collected on a cleaned aluminum window screen (collection mesh). In case 1A, the mesh is grounded. In case 1B, the mesh is connected with a voltage limiting device similar to the one disclosed in U.S. Ser. No. 11/559,282 thereby providing a spark gap shown in FIG. 2 to provide for an abruptly varying field.

75 mm diameter filter media with similar filtration efficiencies (˜95%) were fabricated, and the figure of merit computed for 0.3 μm diameter particles at a face velocity of 5.3 cm/s. The FoM for the grounded media (case 1A) was 37 kPa⁻¹ while that for the spark gap media (case 1B) was 55 kPa⁻¹.

The enhancement due to electric charge was further demonstrated by removing the charge by exposing the two filters to isopropyl alcohol. Once the electret enhancement was removed the FoM is 31 kPa⁻¹ for the grounded filter (case 1A) and 34 kPa⁻¹ for the spark-gap filter (case 1B).

These results show that the fibers spun onto the mesh with the spark gap have higher charge and hence make a better electret filter. The AFD of the filter media was about 108 nm with SD of about 56 nm. The slope of pressure drop versus velocity, specific pressure drop, was 7.6±2 Pa s/cm. The nanofiber mat weight basis was 1.6 g/cm for the grounded filter (case 1A) and 2.8 for case 1B. Even the grounded filter in the example provides a structure (AFD, basis weight, specific pressure drop) and resulting FoM not obtainable via conventional means. FoM values over 20 kPa⁻¹ for non-electret media are not realized via existing methods.

The example above uses polysulfone but improved electret filters would be expected from other polymers such as polystyrene (PS), polyacrylonitrile (PAN), polycarbonate (PC), PVDF, Polymer methyl methacrylate, polyurethane, polyesters, polyamides, and polyvinyl chloride, polyvinylidene based polymers, polycaprolactone, and so on. Combinations of polymers with dissimilar dielectric properties should provide for the best electret media; for example PS and PAN.

An alternate approach in one embodiment would be to form an active electret filter by layering conductive and insulating polymer nanofibers and applying a voltage. The media could be charged like a capacitor and particles collected, and then the media discharged for cleaning of the media. Conductive nanofibers in this embodiment could be formed via use of electrically conducting polymers such as polyanaline or by putting conductive nanomaterials such as carbon nanotubes or metallic nanoparticles into the spinning solution.

### Other Application Areas

The resultant nanofiber mat, prepared by any and all of the methods described above, can be removed from the support for other filter or non-filter applications. While the electret properties of charge retention are not of critical importance in many of these application, except for perhaps the add-on nanofiber mat covering and the sensor applications discussed below, the basis weight and specific pressure drop properties of the nanofiber mat is of importance in these applications.

In one example, the plurality of nanofiber layers can be removed from the support; and thereafter attached to a conventional filter medium, a plastic foam, a metallic foam, a semi-conductive foam, a woven material, a nonwoven material, a plastic screen, and a high efficiency particulate air (HEPA) filter. Alternatively, the removed nanofiber mat can be used in areas where nanofiber materials have been applied before such as for example catalysis, battery separators, wound dressing, supports for cell growth, and gas sensors to name a few.

The application of the nanofiber mat materials of the invention would follow techniques similar to those as described in the references below, but would use the electrospinning techniques disclosed herein to produce the fiber mats of the invention.

Various examples of these non-filter applications are given below.

In catalysis applications, the nanofiber mat materials of the invention would be electrospun using polymers including catalytic metal particles (e.g., nanoparticulate metal and metal oxide nanoparticles) that would provide the mechanism for catalysis, similar to that described for example by Demir, M. M., M. A. Gulgun, et al., “Palladium nanoparticles by electrospinning from poly(acrylonitrile-co-acrylic acid)-PdCl2 solutions. Relations between preparation conditions, particle size, and catalytic activity,” previously incorporated herein by reference. Further, as described in U.S. Ser. No. 11/130,269, these nanoparticles can be incorporated into the fibers of the fiber mat during electrospinning. Alternatively, these particles could be added to fibers (containing no particles as electrospun) during formation of the fiber mat, or added after formation of the fiber mat.

In one embodiment of the invention, particles can be applied to the fiber mats after electrospinning. In this embodiment, a solution containing the particles is provided, and the nanofiber mat is immersed into the solution. The solution is selected such that the nanofiber mat does not dissolve but slightly swells the polymers existing in the nanofibers mat. This expansion of the fibers in the network expands the spaces between the fibers, thus opening the network spaces to allow the particles to move in between. Thus, the particles move to the fiber surface due to the Brownian motion. The fiber mat may be immersed in the solution for a period of 10 minutes to 72 hours and may be rinsed with constant solvent flow for 20-30 seconds to ensure the removal of any loosely attached surface particles. The fiber mat may then be placed onto a support and allowed to completely dry before use.

Owing to the small diameter of the nanofibers and the low resistance to fluid flow, the nanofiber mats of the invention offer advantages over traditional catalyst media and prior art nanofiber-based catalyst materials described above in that the available surface area for catalytic reactions can be increased over the prior techniques. The inclusion of nanoparticulate metal and metal oxide nanoparticles in the nanofiber can yield a valuable catalytic material for industrial and biological processes.

Similarly, in battery separator applications, the nanofiber mat materials of the invention would be electrospun using polymers that would be non-reactive with the battery solutions. Owing to the small diameter of the nanofibers and the low resistance to fluid flow, the nanofiber mats offer advantages over traditional battery separator media and prior art nanofiber-based battery separator materials, similar to that described for example by Choi, S. W., S. M. Jo, et al., “An electrospun poly(vinylidene fluoride) nanofibrous membrane and its battery applications,” previously incorporated herein by reference, in that solutions for electrolytic reactions can more readily be transferred from anode to cathode through the fiber mats of the present invention.

Similarly, in wound dressings, the nanofiber mat materials of the invention would be electrospun using biocompatible or biodegradable polymers to provide nanofiber mats which permit free exchange of gases. Further, similar to that described for example by Katti, D. S., K. W. Robinson, et al., “Bioresorbable nanofiber-based systems for wound healing and drug delivery: Optimization of fabrication parameters,” previously incorporated herein by reference, nanofiber mats can retard the ingress of microbes into the wound surface. The fiber mats of the invention can therefore be used as effective wound dressings, especially when added functionality such as haemostasis and controlled drug delivery is built into the structure. Further, as described in U.S. Ser. No. 11/130,269, nanoparticles can be incorporated into the fibers of the fiber mat during the fiber mat formatting or after fiber mat formation as described above. Such nanoparticles can be drug particles designed to release a drug as the fiber mat dissolves over time.

Similarly, in scaffolding for tissue engineering, the nanofiber mat materials of the invention would be electrospun using biodegradable polymers to provide nanofiber mats which would be used to culture cells within the structure, similar to that described for example by Murugan, R. and S. Ramakrishna, “Nano-featured scaffolds for tissue engineering: A review of spinning methodologies,” previously incorporated herein by reference. Once the cells have proliferated, the fiber mat scaffold would be surgically implanted in the body. The high surface area of nanofibers promotes cell attachment, and the high porosity of the construct allows exchange of gases and nutrients.

Similarly, in drug or bioactive material delivery applications, the nanofiber mat materials of the invention would be electrospun using water soluble polymers to provide nanofiber mats which including the above-noted particles (now containing more generally bioactive substances) would be used to provide a controlled delivery of the bioactive substances, similar to that described for example by Jia, H. F., G. Y. Zhu, et al., “Enzyme-carrying polymeric nanofibers prepared via electrospinning for use as unique biocatalysts,” previously incorporated herein by reference. Pharmaceuticals, especially those that are sparingly soluble in water can be delivered using nanofiber devices. The drug compound either dissolves or is distributed as fine particles in the polymer nanofiber matrix. Under physiological conditions, the bioactive agent is released either diffusively or via biodegradation of nanofiber matrix as described in various of the background references. Further, as described in U.S. Ser. No. 11/130,269, nanoparticle bioactive materials can be incorporated into the fibers of the fiber mat during the fiber mat formation, or after fiber mat formation as described above. Such nanoparticles can be drug particles designed to release a drug as the fiber mat dissolves over time.

Similarly, in nanofiber-based composite applications, the nanofiber mat materials of the present invention would be electrospun using polymers such as those described previously that would include carbon and inorganic nanofibers can be used as reinforcing inclusions in plastics formulations to improve their strength and durability, similar to that described for example by Chronakis, I. S. (2005), “Novel nanocomposites and nanoceramics based on polymer nanofibers using electrospinning process—A review.,” incorporated herein by reference.

Similarly, in antibacterial nanofiber mats application, the nanofiber mat materials of the invention would be electrospun using polymers such as those described previously that would additionally include photocatalytic compounds such as titania, similar to that described for example by Kenawy, E. R. and Y. R. Abdel-Fattah, “Antimicrobial properties of modified and electrospun poly(vinyl phenol),” previously incorporated herein by reference. Particles of the photocatalytic compounds could be included as discussed above by addition of particles of these photocatalytic compounds during formation of the fiber mat or after formation of the fiber mat. Exposure of the fiber mat to light in this application produces free-radical species that are biocidal. The same can also be achieved by dispersion of nanoparticles such as those of silver in the nanofibers. In this application, the electrospun fibers would be substantially transparent to the light permitting production of free radicals even in the interior to the fiber mat.

Similarly, in textile applications, electrospun nanofibers made by this technique would be deposited on conventional textile fabrics or incorporated as a component in a multi-layered fabric construct. Inclusion of a nanofiber mat in a textile as a member will enhance the particle filtration effectiveness of the textile material. The nanofiber layer would not only serve as the most-effective filter layer in such a construct, but would also not impact ‘breathability’ of the material as nanofiber mats allow transport of air and moisture through the textile. This application area has interest not only from an environmental standpoint of protecting individuals from dermal exposure to particulates including nanoparticles, but also in military applications where dermal exposure to particles carrying biologically active materials or chemical agents need to be controlled.

Similarly, in sensor applications, the nanofiber mat materials of the invention would be electrospun using polymers such as those described previously that would provide for large surface area nanofibers to be used in gas sensor applications similar to those described by Aussawasathien, D., J. H. Dong, et al. (2005). “Electrospun polymer nanofiber sensors,” previously incorporated herein by reference.

In these non-filter applications, the fiber mats are attached to a support or detachable therefrom. As with the filter applications, the support can be the support used for production of the fiber mat or can be a detachable support permitting for example in the wound dressing application the removal of the support from the injury sites.

Numerous modifications and variations of the present invention are possible in light of the above teachings. It is therefore to be understood that within the scope of the appended claims, the invention may be practiced otherwise than as specifically described herein.

1. A filtration device comprising:
a filtration medium including a plurality of nanofibers having diameters less than 1 micron formed into a fiber mat in the presence of an abruptly varying electric field during electrospinning of the plurality of nanofibers, said nanofibers retaining charge in the filtration medium from the electrospinning; and
a support attached to the filtration medium and having openings for fluid flow therethrough.

2. The device of claim 1, wherein said charge in the filtration medium enhances an efficiency of the filtration medium.

3. The device of claim 1, wherein said nanofibers are formed in the presence of an applied electric field waveform producing the abruptly varying electric field.

4. The device of claim 1, wherein the support comprises:
a conductive support forming the openings.

5. The device of claim 1, wherein the support comprises:
at least one of a filter, a plastic foam, a metallic foam, a semi-conductive foam, a woven material, a nonwoven material, a plastic screen, a textile, and a high efficiency particulate air (HEPA) filter medium.

6. The device of claim 1, wherein the filter has a minimum efficiency reporting value (MERV) between 3 and 12.

7. The device of claim 1, wherein the support has at least one of a conical shape, a curved shape, a circular shape, a planar shape, a spherical shape, and a cylindrical shape, and combinations thereof.

8. The device of claim 1, wherein the support comprises multiple cellular frames arranged adjacent to each other.

9. The device of claim 8, wherein the multiple cellular frames include cylindrical cells.

10. The device of claim 1, wherein the nanofibers are integrally attached one to another at points along respective ones of the nanofibers.

11. The device of claim 1, wherein the nanofibers have an average fiber diameter of less than 500 nm and a standard deviation of the average fiber diameter is in a range of 30-52% of the average fiber diameter.

12. The device of claim 1, wherein the nanofibers comprise:
an average fiber diameter of less than 200 nm;
a standard deviation of the average fiber diameter is less than 52%, and
a basis weight of less than 5 g/m².

13. The device of claim 12, wherein the standard deviation is less than 45%.

14. The device of claim 12, wherein the standard deviation is less than 40%.

15. The device of claim 1, wherein the nanofibers comprise:
an average fiber diameter of less than 100 nm;
a standard deviation of the average fiber diameter is less than 52%; and
a basis weight of less than 5 g/m².

16. The device of claim 15, wherein the standard deviation is less than 45%.

17. The device of claim 51, wherein the standard deviation is less than 40%.

18. The device of claim 1, wherein the filtration medium comprises plural layers of the nanofibers formed in the presence of the abruptly varying electric field.

19. The device of claim 1, wherein the plural layers comprise between 4 to 4000 layers of the nanofibers.

20. The device of claim 1, wherein the plural layers comprise between 10 to 100 layers of the nanofibers.

21. The device of claim 1, wherein the plural layers produce a specific pressure drop of less than 35 Pa s/cm.

22. The device of claim 1, wherein the plural layers produce a specific pressure drop of less than 10 Pa s/cm or less than 15 Pa s/cm.

23. The device of claim 1, wherein the plural layers comprise a thickness between 0.10 and 500 μm.

24. The device of claim 1, wherein the filtration medium has a figure of merit FoM=−Log(Pt)/ΔP,
where Pt is the fractional penetration of an aerosol particle diameter of 0.3 microns and ΔP is a filtration medium pressure drop across the filtration medium corresponding to a face velocity of 5.3 cm/s, and
said figure of merit is greater than 20 kPa⁻¹.

25. The device of claim 24, wherein said support has a support pressure drop that is no more than 30% of said filtration medium pressure drop.

26. The device of claim 24, wherein said figure of merit is greater than 30 kPa⁻¹.

27. The device of claim 24, wherein said figure of merit is greater than 50 kPa⁻¹.

28. The device of claim 1, wherein the nanofibers comprise at least one of a pH degrading material, an enzyme degrading material, and a thermal degrading material.

29. The device of claim 1, wherein the nanofibers comprise a plurality of conductive and insulating layers.

30. The device of claim 1, wherein the support comprises a supplemental filtration medium.

31. The device of claim 30, wherein the supplemental filtration medium comprises a filter upon which said plurality of nanofibers was deposited in the presence of the abruptly varying electric field.

32. The device of claim 31, wherein a figure of merit for said plurality of nanofibers−Log(Pt)/ΔP is greater than 30 kPa⁻¹,
where Pt is the fractional penetration of an aerosol particle diameter of 0.3 microns and ΔP is a filtration medium pressure drop across the filtration medium corresponding to a face velocity of 5.3 cm/s.

33. The device of claim 31, wherein a figure of merit for said plurality of nanofibers−Log(Pt)/ΔP is greater than 50 kPa⁻¹,
where Pt is the fractional penetration of an aerosol particle diameter of 0.3 microns and ΔP is a filtration medium pressure drop across the filtration medium corresponding to a face velocity of 5.3 cm/s.

34. The device of claim 31, wherein the supplemental filtration layer provides filtration for particles larger than a micron in diameter.

35. The device of claim 1, further comprising:
plural supports, with respective ones of the supports including respective nanofiber layers to provide multi-stage filtration.

36. A filtration device comprising:
a support having openings for fluid flow therethrough;
a filtration medium including a plurality of fibers attached to the support, said fibers retaining charge in the filtration medium; and
said filtration medium having a figure of merit FoM=−Log(Pt)/ΔP,
where Pt is the fractional penetration of an aerosol particle diameter of 0.3 microns and ΔP is a filtration medium pressure drop across the filtration medium corresponding to a face velocity of 5.3 cm/s, and
said figure of merit is greater than 20 kPa⁻¹.

37. The device of claim 36, wherein said support has a support pressure drop that is no more than 1-30% of said filtration medium pressure drop.

38. The device of claim 36, wherein said figure of merit is greater than 30 kPa⁻¹.

39. The device of claim 36, wherein said figure of merit is greater than 50 kPa⁻¹.

40. A filtration device comprising:
a support having macroscopic dimensions and openings for fluid flow therethrough;
a filtration medium including a plurality of nanofibers deposited on the support, said nanofibers retaining charge in the filtration medium; and
a part of the plurality of nanofibers adhered to the support to secure the filtration medium to the support.

41. The device of claim 40, further comprising:
an adhesive joining the filtration medium to the support.

42. The device of claim 40, wherein said part of the plurality of nanofibers are integrally attached to the support.

43. The device of claim 40, further comprising:
a sealant disposed on a perimeter of the support to seal the fibers to the support.

44. The device of claim 40, wherein the plurality of nanofibers comprise a thickness between 0.10 and 500 μm.

45. A fiber medium comprising:
a plurality of nanofibers having diameters less than 1 micron formed into a fiber mat in the presence of an abruptly varying electric field, said nanofibers retaining charge in the filtration medium; and
said fiber mat comprising at least one of a filter, a catalytic material source, a battery separator, a wound dressing, a tissue scaffold, a bioactive material source, an antibacterial material source, a textile item, and a sensor.

46. The medium of claims 45, further comprising:
a support attached to the fiber mat.

47. The medium of claim 46, wherein the support is detachable from the fiber mat.

48. A method for forming a filter material, comprising:
providing a support having openings for fluid flow therethrough;
electrospinning nanofibers across an entirety of the openings to form a plurality of nanofiber layers as a filtration medium on the support;
abruptly varying an electric field at the support at least once during electrospinning of the nanofibers; and
retaining charge on said nanofibers after formation of the filtration medium.

49. The method of claim 48, wherein varying comprises:
discharging the support to ground periodically during the electrospinning.

50. The method of claim 48, wherein varying comprises:
applying an electric field to the support and thereafter reducing at least once the applied electric field to a ground potential.

51. The method of claim 48, wherein providing a support comprises:
providing a conductive support.

52. The method of claim 48, further comprising:
applying a sealant to a perimeter of the support to seal the perimeter from particle by-pass of the filter.

53. The method of claim 48, wherein providing a support comprises:
at least one of treating and coating a surface of the support to promote adhesion of nanofibers to the support.

54. The method of claim 48, wherein providing a support comprises:
providing for the support at least one of a conical shaped support, a curve-shaped support, a circular shaped support, a planar shaped support, a spherical shaped support, and a cylindrical shaped support, and combinations thereof.

55. The method of claim 48, wherein providing a support comprises:
providing for the support multiple cellular frames arranged adjacent to each other.

56. The method of claim 48, wherein electrospinning comprises:
forming said nanofiber layers with respective ones of the nanofibers in one layer integrally attached to other nanofibers in an adjacent layer.

57. The method of claim 48, wherein electrospinning comprises:
electrospinning a solution including a polymer dissolved in the solution.

58. The method of claim 48, wherein electrospinning comprises:
electrospinning a molten polymer.

59. The method of claim 48, wherein electrospinning comprises:
electrospinning nanofibers having an average fiber diameter of less than 500 nm, having a standard deviation of the average fiber diameter in a range of 30-52% of the average fiber diameter.

60. The method of claim 48, wherein electrospinning comprises:
electrospinning nanofibers having an average fiber diameter of less than 200 nm, having a standard deviation of the average fiber diameter less than 52%, and having a basis weight of less than 5 g/m².

61. The method of claim 60, wherein electrospinning comprises:
electrospinning nanofibers having for the standard deviation a deviation less than 45%.

62. The method of claim 60, wherein electrospinning comprises:
electrospinning nanofibers having for the standard deviation a deviation less than 40%.

63. The method of claim 48, wherein electrospinning comprises:
electrospinning nanofibers having an average fiber diameter of less than 100 nm, having a standard deviation of the average fiber diameter less than 52%, and having a basis weight of less than 5 g/m².

64. The method of claim 63, wherein electrospinning comprises:
electrospinning nanofibers having for the standard deviation a deviation less than 45%.

65. The method of claim 63, wherein electrospinning comprises:
electrospinning nanofibers having for the standard deviation a deviation less than 40%.

66. The method of claim 48, wherein electrospinning comprises:
electrospinning first nanofibers having a first average fiber diameter; and
electrospinning on the first nanofibers second nanofibers having a second average fiber diameter smaller than the first average diameter.

67. The method of claim 48, wherein electrospinning comprises:
electrospinning first nanofibers having a first average fiber diameter; and
electrospinning on the first nanofibers second nanofibers having a second average fiber diameter larger than the first average diameter.

68. The method of claim 48, wherein electrospinning comprises:
forming between 4 to 4000 layers of the nanofibers on the support.

69. The method of claim 48, wherein electrospinning comprises:
electrospinning plural layers having a specific pressure drop of less than 35 Pa s/cm.

70. The method of claim 48, wherein electrospinning comprises:
electrospinning plural layers having a specific pressure drop of less than 10 Pa s/cm or less than 15 Pa s/cm.

71. The method of claim 48, wherein electrospinning comprises:
electrospinning a plurality of conductive and insulating layers on the support.

72. The method of claim 48, wherein electrospinning comprises:
forming the nanofibers on the support to a thickness between 0.10 to 500 p.m.

73. The method of claim 48, further comprising:
removing the plurality of nanofiber layers from the support; and
attaching the removed layers to at least one of a filter, a plastic foam, a metallic foam, a semi-conductive foam, a woven material, a nonwoven material, a plastic screen, a textile, and a high efficiency particulate air (HEPA) filter medium.

74. The method of claim 48, further comprising:
attaching the plurality of nanofiber layers to a supplemental filtration medium.

75. The method of claim 48, further comprising:
assembling plural of the supports, with respective ones of the supports including respective nanofiber layers to thereby provide multi-stage filtration.

76. The method of claim 48, wherein electrospinning comprises:
providing a controlled atmosphere for the electrospinning.

77. The method of claim 76, further comprising:
controlling at least one of a humidity or a solvent concentration in the atmosphere.

78. The method of claim 77, wherein the controlling comprises:
controlling the humidity to a relative humidity between 5 and 65%.

79. The method of claim 77, wherein the controlling comprises:
controlling the humidity to a relative humidity between 15 and 40%.

80. The method of claim 77, wherein the controlling comprises:
controlling the solvent concentration to a relative concentration in the atmosphere between 10 and 80%.

81. The method of claim 77, wherein the controlling comprises:
controlling the solvent concentration to a relative concentration in the atmosphere between 20 and 45%.

82. The method of claim 48, wherein electrospinning comprises:
electrospinning at least one of a pH degrading material, an enzyme degrading material, and a thermal degrading material.

83. The method of claim 48, further comprising:
detecting an amount of gas or aerosol passing through a portion of the filter being tested.

84. The method of claim 48, further comprising:
using light scattering to detect variations in thickness of the electrospun fibers across the surface of the collector.

85. The method of claim 48, further comprising:
providing relative motion between the electrospinning element and the support in response to detecting local non-uniformities in the filtration medium in order to improve uniformity of the formed filtration medium.

86. The method of claim 48, further comprising:
providing an additive including at least one of a salt and a surfactant to a substance to be electrospun.

87. The method of claim 86, wherein providing an additive comprises
supplying the additive at a concentration between 0.005 to 3 wt. %.

88. The method of claim 48, further comprising:
rotating at least one of the electrospining element and the support during the electrospinning.

89. The method of claim 48, further comprising:
providing a process gas flow through the nanofiber filtration medium on the support during the electrospinning.

90. The method of claim 89, further comprising:
monitoring a pressure drop across the filtration medium during the electrospinning.
